(19) United States
(12) Patent Application Publication
(10) Pub. No.: US 2008/0253959 A1
(43) Pub. Date: Oct. 16, 2008

(54) Synthesis crystalline molecular sieves

(76) Inventors: Ivy D. Johnson, Lawrenceville, NJ (US); Glenn R. Sweeten, Gibbstown, NJ (US); Robert A. Crane, Hellertown, PA (US)

Correspondence Address: ExxonMobil Research & Engineering Company, P.O. Box 900, 1545 Route 22 East, Annandale, NJ, 08801-0900, US

(21) Appl. No.: 11/731,870

(22) Filed: Mar. 30, 2007

(51) Int. Cl. C01B 33/20; C01B 39/00

(52) U.S. Cl. 423/702; 423/700

(57) ABSTRACT

In a process for synthesizing a crystalline molecular sieve, an aqueous synthesis mixture is produced capable of forming the crystalline molecular sieve. Crystallization of the synthesis mixture is induced so as to form crystals of said molecular sieve in the synthesis mixture and, when crystallization is complete, the molecular sieve crystals are allowed or caused to separate from the remainder of the synthesis mixture to produce a solid phase comprising said molecular sieve crystals and a supernatant liquid phase. The supernatant liquid phase is then decanted from the solid phase to recover the molecular sieve crystals and the crystals are dried without initially being subjected to washing or filtration.

### FIELD

The present invention relates to a process for synthesizing crystalline molecular sieves.

### BACKGROUND

Crystalline molecular sieves have a 3-dimensional, four-connected framework structure of corner-sharing [TO₄] tetrahedra, where T is any tetrahedrally coordinated cation. Among the known forms of molecular sieve are silicate molecular sieves, which contain a three-dimensional microporous crystal framework structure of [SiO₄] corner sharing tetrahedral units, aluminosilicate molecular sieves, in which the framework includes [AlO₄] as well as [SiO₄] tetrahedral units, silicoaluminophosphate (SAPO) molecular sieves, which contain [SiO₄], [AlO₄] and [PO₄] tetrahedral units and aluminophosphate (AlPO) molecular sieves, which contain [AlO₄] and [PO₄] tetrahedral units.

The synthesis of crystalline molecular sieves is a multi-stage and time-consuming process. Thus, typically, synthesis involves initially heating an aqueous mixture comprising a source of the or each [TO₄] tetrahedral unit in the desired molecular sieve and a directing agent, generally a nitrogen-containing organic base, in a pressure-resistant container at elevated temperatures for several hours to a few days until a crystalline product is obtained. The synthesis mixture can then be pumped into one or more decantation vessels where the crystalline product is allowed to settle to the bottom and the remaining liquor (“mother” liquor) is removed. After decantation of the mother liquor, the crystals are washed with deionized water and then separated from the water by filtration. The washed and filtered crystals are then dried before being subjected to a variety of finishing steps, such as extrusion, ion exchange and calcination.

In a typical synthesis process, the decantation and filtration steps can add several days to the overall production time. For example, filtration of many molecular sieves is slow and labor intensive especially where the materials crystallize with a lamellar morphology. Using either belt filtration or filter presses, the layered particles tend to align on the filter cloths and blind them off, that is, not allow wash water to adequately pass through the filtercake. This can be alleviated in part with flocculation aids that pre-form particles prior to deposition on the belt. However, there are limits to the improvements that even an optimized flocculation can provide. In addition, the filtration steps produce a large quantity of wastewater, often contaminated with organic residue which must be disposed of in an environmentally friendly manner.

There is therefore significant interest in streamlining the molecular sieve synthesis process by minimizing or eliminating time-consuming and/or expensive separation and purification steps, provided this can be achieved without significant reduction in the properties of the resultant zeolite.

For example, U.S. Pat. No. 6,805,851 discloses a process for the preparation of a crystalline solid comprising at least one zeolitic material, in which the solid is crystallized from at least one precursor compound and the reaction discharge of the crystallization is fed directly to a drying stage, drying being carried out in an atmosphere comprising less than 10% by volume of oxygen and at least one inert gas, wherein the crystallization is carried out in the presence of at least one template compound, and, after contact with the atmosphere in the form of a carrier gas stream with the reaction discharge to be dried, condensable template compounds present in the stream are condensed out.

Similarly, U.S. Pat. No. 5,558,851 discloses a method for preparing a crystalline aluminosilicate zeolite from a reaction mixture containing only sufficient water so that the reaction mixture may be shaped if desired. In the method, the reaction mixture is heated at crystallization conditions and in the absence of an external liquid phase, so that excess liquid need not be removed from the crystallized material prior to drying the crystals. In this way, the need for post-crystallization filtering and decanting is allegedly avoided.

U.S. Pat. Nos. 6,524,984 and 7,074,383 disclose a process for the preparation of zeolitic catalysts comprising microspheres of zeolite and oligomeric silica, which consists essentially of: a) synthesizing said zeolite under hydrothermal conditions, at autogenous pressure, and in the presence of tetra-alkyl-ammonium hydroxide as templating agent to obtain a suspension containing zeolite crystals and tetra-alkyl-ammonium hydroxide; b) optionally adding as a silica source when necessary tetra-alkylorthosilicate to a suspension resulting from step a); c) spray drying said suspension resulting from step a) or step b); and d) calcining of the product resulting from step c).

Current investigations of molecular sieve synthesis processes have shown that an important step in the process is the removal of salts and unreacted oxide species from the mother liquor remaining after the crystallization is complete. Thus, in zeolite crystallization, typical silica utilization is between 75% and 90%, leaving anywhere from 10% to 25% of the silica in an amorphous or unreacted phase. Although this unreacted silica could by itself merely be considered as a diluent, during subsequent drying of the crystal, the unreacted silica tends to react with alkali metal species, generally sodium compounds, also present in the mother liquor to form sodium silicate. It has been found that the sodium in this silicate species is very difficult if not impossible to remove from the crystal through subsequent crystal processing, including extrusion and NH₄ exchange, and poisons the acid sites in the zeolite resulting in an undesirable reduction in activity.

According to the present invention, it has now been found that decantation of the mother liquor from the zeolite crystals is effective in removing most of the unreacted silica so that the zeolite crystals can be fed directly from the decantation step to a drying step, without intermediate washing and filtration, and with the formation of silicate poisons during the drying step being minimized. Any residual alkali metal species on the zeolite can be removed during the subsequent ion exchange that is practiced regardless of the prior treatment of the crystal. Similarly it is found that intermediate washing and filtration can be eliminated in the synthesis of other molecular sieves, such as AlPOs and SAPOs, without significant loss in the activity of the final product.

### SUMMARY

The present invention resides in a process for synthesizing a crystalline molecular sieve, the process comprising:

(a) forming an aqueous synthesis mixture capable of forming said crystalline molecular sieve;

(b) inducing crystallization of said synthesis mixture to form crystals of said molecular sieve in the synthesis mixture;

(c) allowing or inducing said molecular sieve crystals to separate from the remainder of the synthesis mixture to produce a solid phase comprising said molecular sieve crystals and a supernatant liquid phase;

(d) decanting the supernatant liquid phase from the solid phase to recover the molecular sieve crystals; and

(e) drying the molecular sieve crystals recovered in (d) without initially subjecting the crystals to washing or filtration.

Conveniently, (c) is conducted in the presence of one or more flocculants or coagulants.

Conveniently, after (b) and prior to (c), the synthesis mixture is diluted with further water, typically in an amount such that the weight ratio of synthesis mixture to water diluent is between about 1:1 and about 1:10.

Conveniently, said drying is conducted in a spray drier, a flash dryer and/or a flash calciner, especially a spray drier.

Conveniently, the synthesis mixture in (a) further comprises an organic directing agent and the process further includes calcining the dried molecular sieve crystals to at least partially remove the organic directing agent.

In one embodiment, said molecular sieve comprises a zeolite and said aqueous synthesis mixture comprises a source of a tetravalent metal oxide, optionally a source of a trivalent metal oxide, and a source of alkali metal cations.

Conveniently, the process further includes subjecting the recovered molecular sieve crystals to ion exchange, such as ammonium ion exchange, prior to or after the drying (e). In one embodiment, the process further includes calcining the ammonium exchanged crystals to at least partially convert the zeolite to the hydrogen form.

### BRIEF DESCRIPTION OF THE DRAWINGS

FIG. 1 is a flow diagram of a conventional zeolite synthesis process.

FIG. 2 is a flow diagram of a zeolite synthesis process according to one example of the present invention.

### DETAILED DESCRIPTION OF THE EMBODIMENTS

The present invention relates to a process for synthesizing a crystalline molecular sieve, in which recovery of the molecular sieve crystals from the synthesis mixture is simplified so as to provide a more efficient and reduced cost process. Moreover, these improvements are achieved substantially without impacting the properties of the final molecular sieve. For simplicity the process will be described with reference to the production of silicate and aluminosilicate zeolites, but it is to be appreciated that the process is equally applicable to the synthesis of other molecular sieves, such as AlPOs and SAPOs.

In the present process, as with any conventional zeolite synthesis process, an aqueous synthesis mixture is initially prepared by mixing water with a source of silica or other tetravalent metal oxide, such as an oxide of tin, titanium and/or germanium, optionally with a source of alumina or other trivalent metal oxide, such as an oxide of boron, iron, indium, and/or gallium and with an organic directing agent, generally a nitrogen-containing organic base, effective to direct the synthesis of the desired zeolite. The synthesis mixture is produced in or is transferred to a suitable reactor, generally a pressure-resistant autoclave, and then heated at elevated temperatures, typically about 50° C. to about 250° C., for several hours to a few days, typically about 2 hours to about 14 days, until a crystalline product is obtained.

When crystallization is complete, the crystalline product is recovered from the synthesis mixture which, in the present process, is achieved by decantation of the synthesis mixture from the crystalline product without filtration and any washing normally associated with filtration. Thus, it has now been found that decantation of the synthesis mixture is effective in removing most of the unreacted silica so that the zeolite crystals can be fed directly from the decantation step to a drying step, without intermediate washing and filtration, and with the formation of silicate poisons during the drying step being minimized. Any residual alkali metal species on the zeolite can then be removed during subsequent ion exchange that forms part of the zeolite finishing procedure.

Decantation can be performed in the same vessel as that used to conduct the zeolite synthesis, although more frequently the synthesis mixture with the crystalline product is transferred to a separate decantation vessel. In either case, decantation involves initially allowing or inducing the zeolite crystals to separate from the remainder of the synthesis mixture. This is typically achieved by allowing the synthesis mixture to stand until the crystals separate under gravity from the synthesis mixture and collect at the bottom of the vessel, which, depending on factors such as the viscosity of the synthesis mixture, may take from about 1 hour to about 96 hours. Separation is complete when the synthesis slurry has divided into a clear supernatant liquid phase above a solid crystalline phase. Alternatively, separation of the zeolite crystals can be induced by causing the synthesis mixture to rotate in a centrifuge.

After the synthesis mixture has separated into a clear supernatant phase and a solid crystalline phase, the supernate can be carefully poured or siphoned off, typically to be recycled to the zeolite synthesis step, while the crystalline phase is transferred directly to the drying step. In this respect, it is to be appreciated that the term “decanting” is used herein to include physical separation of the supernatant liquid phase from the solid crystalline phase by pouring, siphoning or even centrifuging but to exclude filtration.

To facilitate separation of the zeolite crystals, the synthesis mixture may be diluted with water, generally deionized water, before the synthesis mixture is allowed to stand or is subjected to centrifugation. Typically, the amount of water diluent added is such that the weight ratio of slurry to water diluent is between about 1:1 and about 1:10, preferably between about 1:4 and about 1:6.

Separation of the zeolite crystals from the synthesis mixture prior to decantation may also be facilitated by the addition of one or more flocculants to the synthesis mixture. Conveniently, the or each flocculant is added to the synthesis mixture after crystallization in an amount of about 0.005 to about 0.100 wt %, preferably from about 0.01 to about 0.05 wt %, more preferably from about 0.15 to about 0.04 wt % flocculant based on the solid molecular sieve product. The flocculants are typically added to the slurry at room temperature, and are preferably added as a solution. If a solid flocculant is used then it is preferable that a substantially homogeneous flocculant solution is prepared by dissolving the solid flocculant in a liquid medium, preferably water.

There are many types of flocculants, including both inorganic and organic flocculants, suitable for use in facilitating zeolite crystal separation. Inorganic flocculants are typically aluminum or iron salts that form insoluble hydroxide precipitates in water. Non-limiting examples include aluminum sulfate, poly(aluminum chloride), sodium aluminate, iron(III)-chloride, sulfate, and sulfate-chloride, iron(II)sulfate, and sodium silicate (activated silica). The major classes of flocculants are: (1) nonionic flocculants, for example, polyethylene oxide, polyacrylamide (PAM), partially hydrolyzed polyacrylamide (HPAM), and dextran; (2) cationic flocculants, for example, polyethyleneimine (PEI), polyacrylamide-co-trimethylammonium, ethyl methyl acrylate chloride (PTAMC), and poly(N-methyl-4-vinylpyridinium iodide); and (3) anionic flocculants, for example, poly(sodium acrylate), dextran sulfates, alum(aluminum sulfate), and/or high molecular weight ligninsulfonates prepared by a condensation reaction of formaldehyde with ligninsulfonates, and polyacrylamide. In a preferred embodiment, where the synthesis mixture includes the presence of water, it is preferable that the flocculant used is water soluble. Additional information on flocculation is discussed in T. C. Patton, Paint Flow and Pigment Dispersion—A Rheological Approach to Coating and Ink Technology, 2nd Edition, John Wiley & Sons, New York, p. 270, 1979, which is fully incorporated by reference.

Where the synthesis mixture contains an organic directing agent, part of the directing agent will normally become trapped in the pore structure of the zeolite. However, at least part the directing agent will remain in the synthesis mixture after crystallization is complete. Moreover, since the directing agent is often the most expensive component in the synthesis mixture and can pose downstream disposal problems if left in the synthesis mixture, it will normally be desirable to remove at part of the free directing agent from the synthesis mixture prior to or after the decantation step. This can be effected by subjecting the synthesis mixture to one or more flashing steps, which typically involves taking advantage of the azeotropes formed between organic liquids and water. The removal of organic directing agents from zeolite synthesis slurries depends on the relative volatility of the organic with respect to water. If the relative volatility is >1.5, then the procedure is fairly simple and the flashing is performed at a temperature low enough to complete the process in a reasonable period of time. If on the other hand the relative volatility is <1, separation is extremely difficult. Exceptions to this case occur when the organic agent forms a minimum boiling azeotrope with water. For these mixtures, it is possible to distill off the organic phase without the solution decomposing.

After decantation of the aqueous supernatant phase from the zeolite crystals, and without intermediate washing and/or filtration, the crystals are dried to remove most or all of the water entrained on the crystals from the synthesis mixture. The drying is generally conducted in a spray drier, a flash dryer and/or a flash calciner, especially a spray drier. Typically, the drying is conducted in the presence of a drying gas, usually air, at a temperature between about 100° C. and about 450° C., such as between about 125° C. and about 250° C. Conveniently, the drying is arranged so that the dried zeolite crystals contain from about 8 wt % to about 12 wt % water.

After drying, the zeolite crystals can be stored prior to finishing and use. Finishing normally involves one or more of the steps of combining the zeolite with a binder or matrix; forming the zeolite/binder into particles of the desired size and shape, generally by extrusion; ion exchange particularly ammonium ion exchange to assist in converting the zeolite into the catalytically active hydrogen form; and calcination particularly to remove organic directing agent trapped in the pore system of the zeolite. Calcination typically involves heating the zeolite comprising the directing agent at a temperature of from about 200° C. to about 800° C. in the presence of an oxygen-containing gas. In some cases, it may be desirable to heat the molecular sieve in an environment having a low or zero oxygen concentration. This type of process can be used for partial or complete removal of the organic directing agent from the intracrystalline pore system. Calcination to remove the organic directing agent can be effected prior to ion exchange, but generally is conducted after ammonium ion exchange as part of the zeolite activation step. Similarly, calcination can be effected prior to combining the zeolite with a binder or matrix, but more typically is conducted after extrusion of the zeolite/binder combination.

In an alternative embodiment, at least one of the steps of combining the zeolite with a binder or matrix; forming the zeolite/binder into particles of the desired size and shape; and ion exchange can be performed directly after decantation of the aqueous supernatant phase from the zeolite crystals and before drying of the crystals. In such a case, the drying could be conducted as part of a subsequent two-step heating step to dry the crystals and then calcine the crystals to remove the organic directing agent and/or to convert the ammonium-exchanged material to the hydrogen form.

Suitable binders and/or matrix materials which can be combined with the zeolite crystals include materials that provide additional hardness or catalytic activity to the finished catalyst. Such materials can be inert or catalytically active and include compositions such as kaolin and other clays, various forms of rare earth metals, other non-zeolite catalyst components, zeolite catalyst components, alumina or alumina sol, titania, zirconia, quartz, silica or silica sol, and mixtures thereof. These components are also effective in reducing overall catalyst cost, acting as a thermal sink to assist in heat shielding the catalyst during regeneration, densifying the catalyst and increasing catalyst strength. When blended with such components, the amount of molecular sieve contained in the final catalyst product ranges from 10 to 90 weight percent of the total catalyst, preferably 20 to 70 weight percent of the total catalyst.

In one embodiment, the present process is employed in the synthesis of a zeolite of the MCM-22 family. The term “MCM-22 family material” (or “material of the MCM-22 family” or “molecular sieve of the MCM-22 family” or “MCM-22 family zeolite”), as used herein, includes one or more of:
molecular sieves made from a common first degree crystalline building block unit cell, which unit cell has the MWW framework topology. (A unit cell is a spatial arrangement of atoms which if tiled in three-dimensional space describes the crystal structure. Such crystal structures are discussed in the “Atlas of Zeolite Framework Types”, Fifth edition, 2001, the entire content of which is incorporated as reference);
molecular sieves made from a common second degree building block, being a 2-dimensional tiling of such MWW framework topology unit cells, forming a monolayer of one unit cell thickness, preferably one c-unit cell thickness;
molecular sieves made from common second degree building blocks, being layers of one or more than one unit cell thickness, wherein the layer of more than one unit cell thickness is made from stacking, packing, or binding at least two monolayers of one unit cell thickness. The stacking of such second degree building blocks can be in a regular fashion, an irregular fashion, a random fashion, or any combination thereof; and
molecular sieves made by any regular or random 2-dimensional or 3-dimensional combination of unit cells having the MWW framework topology.

Molecular sieves of the MCM-22 family include those molecular sieves having an X-ray diffraction pattern including d-spacing maxima at 12.4±0.25, 6.9±0.15, 3.57±0.07 and 3.42±0.07 Angstrom. The X-ray diffraction data used to characterize the material are obtained by standard techniques using the K-alpha doublet of copper as incident radiation and a diffractometer equipped with a scintillation counter and associated computer as the collection system.

Materials of the MCM-22 family include MCM-22 (described in U.S. Pat. No. 4,954,325), PSH-3 (described in U.S. Pat. No. 4,439,409), SSZ-25 (described in U.S. Pat. No. 4,826,667), ERB-1 (described in European Patent No. 0293032), ITQ-1 (described in U.S. Pat. No. 6,077,498), ITQ-2 (described in International Patent Publication No. WO97/17290), MCM-36 (described in U.S. Pat. No. 5,250,277), MCM-49 (described in U.S. Pat. No. 5,236,575), MCM-56 (described in U.S. Pat. No. 5,362,697), UZM-8 (described in U.S. Pat. No. 6,756,030), and mixtures thereof.

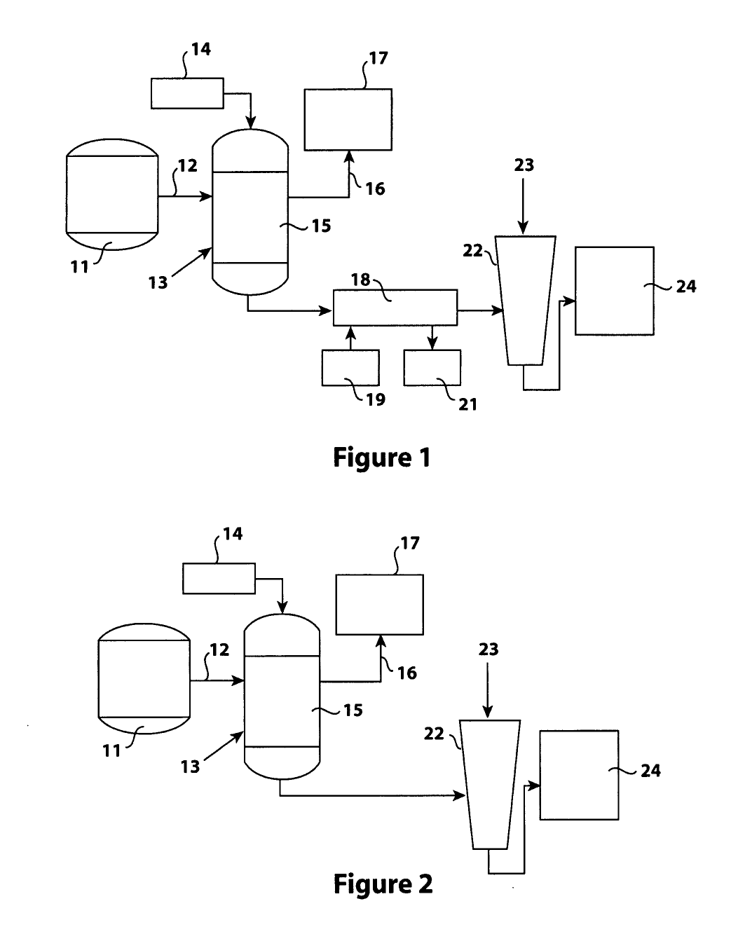

Referring to the drawings, FIG. 1 illustrates a conventional zeolite synthesis process and in particular shows the various stages involved in recovery of the zeolite product from synthesis mixture. In the process shown in FIG. 1, crystallization of the synthesis mixture is conducted in an autoclave 11 and the resulting product mixture, containing the zeolite crystals, is fed via line 12 to a decantation vessel 13. A reservoir 14 feeds water diluent to the synthesis mixture in the vessel 13, where the zeolite crystals are allowed to settle to the bottom of the vessel 13 and the remaining liquor (“mother” liquor) 15 is removed through line 16 and collected in a container 17 for recycle to the autoclave 11. After decantation of the mother liquor, the zeolite crystals are transferred to a filtration system 18, typically a belt filter or a filter press, where the crystals are washed with fresh deionized water 19 and then separated from the waste water 21 by means of the filtration system. The washed and filtered crystals are then fed to a drier 22, such as a spray drier, a flash dryer and/or a flash calciner, generally a spray drier, where the crystal are dried, normally in a current of air 23 and typically at a temperature of about 200° C. to about 350° C. The dried crystals are then collected in a drum 24 and stored before being subjected to the desired finishing steps.

Referring now to FIG. 2, which illustrates a process according to one example of the present invention and which uses the same reference numerals to designate like components to those used in the process shown in FIG. 1, the crystallization is again conducted in the autoclave 11 and the resulting product mixture, containing the zeolite crystals, is fed via line 12 to the decantation vessel, 13. However, in the process of FIG. 2, after decantation of the mother liquor, the zeolite crystals are transferred directly to the drier 22, without initial washing and filtration, and then the dried crystals are collected in the drum 24 for storage.

The invention will now be more particularly described with reference to the following Examples.

### EXAMPLE 1 (COMPARATIVE)

The crystalline zeolite MCM-22 was synthesized from a reaction mixture having the following formulation:

| | | |
|---|---|---|
| Water | 1004.7 | g, |
| 50% aqueous solution NaOH | 31.3 | g |
| 5% aqueous solution Na Aluminate | 52.5 | g |
| Degussa Ultrasil, PM | 269.3 | g |
| Hexamethyleneimine | 142 | g |

After the above reagents were mixed, the mixture was transferred to a 5-gallon autoclave and was stirred at 90 rpm and 300° F. (149° C.) under autogeneous pressure for 96 hours, at which time crystallization of the desired MCM-22 was deemed complete. The autoclave was cooled to 220° F. (104° C.) and the organic was flashed out of the autoclave to a collection vessel. The autoclave was cooled to ambient conditions. The crystals in the autoclave were reslurried in an amount of deionized water equal to the amount of removed organic and the material was flashed a second time. The resultant reactor slurry, including crystals and mother liquor, was discharged without decantation or centrifugation to separate the zeolite crystals from the mother liquor.

A 250 g sample of the reactor slurry was collected, filtered (not washed) and dried for analysis. Analysis gave the initial crystal composition including the unreacted silica and sodium salts. The results are shown in Table 1.

### EXAMPLE 2 (COMPARATIVE)

A 1000 g sample of the reactor slurry from Example 1 was filtered after washing with deionized water in the amount of 2 volumes of the slurry per volume of deionized water. The crystals were then resuspended in deionized water to make a 9% solids slurry for feeding to a Buchi spray dryer. The spray dryer was heated to 225° C. (437° F.) and adjusted to an aspirator setting of 6 and an air injection setting of 700. Initially deionized water was pumped through the spray drier at 10 cc/minute until the temperature was lined out and then the 9% MCM-22 solids slurry was pumped through the spray drier also at 10 cc/minute. The dried product was analyzed and the results are shown in Table 1.

### EXAMPLE 3 (COMPARATIVE)

The spray drying process of Example 2 was repeated with a further 1000 g sample of the reactor slurry from Example 1, but without removing the mother liquor through decantation, filtration, or washing. The dried product was analyzed and the results are shown in Table 1.

### EXAMPLE 4 (COMPARATIVE)

The process of Example 1 was repeated and 5000 ml of the reactor slurry, including crystals and mother liquor, was diluted with 5000 ml of deionized water and allowed to settle for 16 hours. A solution of 1.5 g of Magnifloc C-1555 (supplied by Cytec Industries, Inc) flocculant in 8000 ml of deionized water was then added to the slurry and the mixture was stirred gently. A second flocculant solution of 4.0 g of Magnifloc C-591 in 8000 ml of deionized water was then added to the mixture and again the mixture was stirred gently. The final mixture was allowed to settle for a further 16 hours and the clear supernate eas decanted from the MCM-22 crystals.

The crystals were then resuspended in deionized water to make a 7 wt % solids slurry and were spray dried using the Buchi spray dryer and the same operating conditions in Example 2. The dried product was analyzed and the results are shown in Table 1.

### EXAMPLE 5 (COMPARATIVE)

The spray dried MCM-22 crystals from Example 2 were combined with Versal 300 alumina in a 65:35 ratio crystal to alumina. Water was added to the mixtures to provide a solids level 44.2% by weight. This “mull” mix was mixed well using a mini-extruder for sufficient time to create a uniform, activated paste, which was then processed through a 2 inch extruder with die plates or die inserts to give 1/16″ diameter cylindrical shaped extrudates. The green extrudates were subsequently dried at 125° C. for a minimum of 8 hours.

After drying, the green extrudates were charged to a muffle pot and placed in the furnace, where the extrudates were heated at 5° F./minute (2.8° C./minute) to 900° F. (482° C.) in 5 v/v N₂ and then held at this temperature for 3 hours. The calcined materials were cooled to ambient conditions, removed from the muffle pot and charged to an exchange column.

The extrudates were humidified by blowing saturated air over them and then a solution of 1 N NH₄NO₃ (2 volume of NH₄NO₃ solution per volume of catalyst) was circulated through the column for 1 hour at ambient temperature. The NH₄NO₃ solution was replaced with a fresh solution and the exchange repeated until the targeted Na content was achieved. The exchanged extrudates were dried at 250° F. (121° C.) for about 18 hours and submitted for Na analysis.

When the sodium content was <0.1 wt %, the extrudate was charged to the muffle calciner, heated at 5° F./minute (2.8° C./minute) to 1000° F. (538° C.) in 5 v/v air and held at this temperature for 24 hours. After cooling to ambient conditions, the calcined extrudate was submitted for alpha analysis to determine the acidity of the catalyst. The results are shown in Table 1.

### EXAMPLE 6 (COMPARATIVE)

The extrusion, ion exchange, and calcination procedures described in Example 5 were repeated for the spray dried unwashed MCM-22 crystals from Example 3 and the results are shown in Table 1 under “Example 6 product”. In a further test, the ion exchange procedure of Example 3 was modified to include three exchanges at ambient temperature, followed by two further exchanges with the NH₄NO₃ solution heated to 160° F. (71° C.) and three additional exchanges with a 1N NH4OH solution at 120° F. (49° C.). After the final exchange, the sample was subjected to the final air calcination described in Example 5 and submitted for alpha analysis to determine the acidity of the catalyst. Again, the results are shown in Table 1 under “Example 6 product (after additional exchanges)”.

### EXAMPLE 7

The extrusion, ion exchange, and calcination procedures described in Example 5 were repeated for the decanted but not filtered MCM-22 crystals from Example 4, except the ion exchange involved three exchanges at ambient temperature, followed by three further exchanges with a 1N NH4OH solution at 120° F. (49° C.). After the final exchange, the sample was subjected to the final air calcination described in Example 5 and submitted for alpha analysis to determine the acidity of the catalyst. Again, the results are shown in Table 1.

TABLE 1

| | Na, | SiO₂, | Al₂O₃, | |
|---|---|---|---|---|
| | Wt % | Wt % | Wt % | Alpha |
| Example 1 product | 2.59 | 69.1 | 4.46 | NA |
| Example 1 Mother | 1.36 | 2.23 | 5 ppm | |
| Liquor | | | | |
| Example 2 product | 1.59 | 67.5 | 4.61 | NA |
| Example 3 product | 3.52 | 62.2 | 4.96 | NA |
| Example 4 product | 2.87 | 69 | 4.26 | NA |
| Example 5 product | 0.042 | NA | NA | 420 |
| Example 6 product | 1.060 | NA | NA | |
| Example 6 product (after | 0.300 | NA | NA | 250 |
| additional exchanges) | | | | |
| Example 7 product | 0.09 | NA | NA | 430 |

It will be seen from Table 1 that the zeolite recovered by simple decantation of the mother liquor gave a catalyst (Example 7) with a similar low sodium level and high alpha value after ammonium exchange and calcination as the final catalyst (Example 5) obtained by washing and filtration to recover the zeolite. In contrast, the catalyst (Example 6) obtained without decantation or washing and filtration to recover the zeolite had a higher sodium level and lower alpha value, and even extensive additional ion exchange could not lower the sodium level to a value approaching that of the Example 5 catalyst.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A process for synthesizing a crystalline molecular sieve, the process comprising:
(a) forming an aqueous synthesis mixture capable of forming said crystalline molecular sieve;
(b) inducing crystallization of said synthesis mixture to form crystals of said molecular sieve in the synthesis mixture;
(c) allowing or inducing said molecular sieve crystals to separate from the remainder of the synthesis mixture to produce a solid phase comprising said molecular sieve crystals and a supernatant liquid phase;
(d) decanting the supernatant liquid phase from the solid phase to recover the molecular sieve crystals; and
(e) drying the molecular sieve crystals recovered in (d) without initially subjecting the crystals to washing or filtration.

2. The process of claim 1 wherein (c) is conducted in the presence of at least one flocculant.

3. The process of claim 2 wherein said at least one flocculant is present in an amount of about 0.005 to about 0.100 wt % flocculant based on said zeolite crystals.

4. The process of claim 1 wherein, after (b) and prior to (c), the synthesis mixture is diluted with further water.

5. The process of claim 4 wherein the synthesis mixture is diluted with further water in an amount such that the weight ratio of synthesis mixture to water diluent is between about 1:1 and about 1:10.

6. The process of claim 1 wherein said drying is conducted in a spray drier, a flash dryer and/or a flash calciner.

7. The process of claim 1 wherein said drying is conducted in a spray drier.

8. The process of claim 1 and further including forming the molecular sieve crystals into a desired shape, before or after the drying (e).

9. The process of claim 8 wherein the molecular sieve crystals are formed into a desired shape by extrusion.

10. The process of claim 1 wherein said synthesis mixture further comprises an organic directing agent.

11. The process of claim 10 and further including calcining the dried zeolite crystals to at least partially remove the organic directing agent.

12. The process of claim 1 wherein said molecular sieve comprises a zeolite and said aqueous synthesis mixture comprises a source of a tetravalent metal oxide, optionally a source of a trivalent metal oxide, and a source of alkali metal cations.

13. The process of claim 12 and further including subjecting the zeolite crystals to ion exchange, before or after the drying (e).

14. The process of claim 12 and further including subjecting the zeolite crystals to ammonium ion exchange, before or after the drying (e).

15. The process of claim 14 and further including calcining the ammonium exchanged zeolite crystals to at least partially convert the zeolite to the hydrogen form.

16. The process of claim 12 wherein said zeolite is a zeolite of the MCM-22 family.

17. The process of claim 12 wherein said source of a tetravalent metal oxide is a source of silica.

18. The process of claim 12 wherein said source of a trivalent metal oxide is present and is a source of alumina.
